(19) United States
(12) Patent Application Publication
(10) Pub. No.: US 2010/0063751 A1
(43) Pub. Date: Mar. 11, 2010

(54) BUILDING STRUCTURE MONITORING

(76) Inventor: Igor Gennadevich Korolev, Moscow (RU)

Correspondence Address: Aleksandr Smushkovich, PO Box 140505, Brooklyn, NY, 11214, US

(21) Appl. No.: 12/448,691

(22) PCT Filed: Aug. 10, 2007
(86) PCT No.: PCT/RU2007/000444

§ 371 Date: Jun. 30, 2009

(30) Foreign Application Priority Data
Apr. 25, 2007 (RU) PCT/RU2007/000203

(51) Int. Cl. G01L 1/00; G06F 19/00

(52) U.S. Cl. 702/41; 73/862.621

(57) ABSTRACT

A method for monitoring a building structure, having construction and reinforcement elements with pre-calculated threshold stretching and compression loads, comprises—determining actual stretching and compression loads developed therein based on data measured for the loads, —comparing the determined loads with the corresponding pre-calculated loads, and —displaying the determined loads and the compared results on a monitoring terminal, wherein the measured data are generated in real time or in a predetermined time mode, and obtained by measuring deviations of electric or magnetic parameters at the reinforcement elements, and by compression-measuring sensors installed between the construction elements. A system for determination of failure conditions of the building structure includes a monitoring device capable of connecting to stretching and compression loads measuring means. The device includes a terminal associated with the measuring means, capable of processing the loads data in real time or within a pre-set time interval, and displaying the data.

### CROSS-REFERENCE TO RELATED APPLICATIONS

This application is a U.S. national phase application of a PCT application PCT/RU2007/000444 filed on 10 Aug. 2007, published as WO2008/133544, whose disclosure is incorporated herein in its entirety by reference, which PCT application claims priority of PCT/RU2007/000203 filed on 25 Apr. 2007.

### FIELD OF THE INVENTION

This invention refers to the field of control (inspection) of building structures during exploitation thereof.

### BACKGROUND OF THE RELATED ART

A problem, which one encounters during an inspection of a building structure, is that of getting the full, reliable, and timely obtaining data on the conditions of the structure as a whole and its separate elements. The problem and the ways to resolve it were described, for example, in an article entitled “Monitoring of buildings and structures” by S. V. Nikolaev et al, in Materials of the IV international Scientific-Practical Conference “Modern systems and devices of the complex security and fire protection of construction objects, “Stroibezopasnost-2006”, 10 Jan. 2007.

Well known are also certain types of building structures monitoring as per Patent of Russian Federation No. 2250444 issued 10 Jan. 2004 and U.S. Pat. No. 6,725,097 issued 20 Apr. 2004 (considered the closest prior art analogue). Such a method includes determining the load on building structures elements, comparison with the projected load values, and display on a monitoring terminal (computer and monitor) of the results of load calculation and the results of their comparison with the projected values, while tying them up to the building structure.

The main shortcoming of the previously used methods of building structure monitoring is a long period, which excludes control over the condition of the structure both in real-time or close to a real period of time and does not allow ascertaining the timeliness of information flow on a critical state of the structure.

The aforementioned patents also describe systems, which include terminal monitoring that allows processing data on a building structure's elements and determination of a pre-failure condition of the building structure.

The main drawback of all previously used systems of building structures' monitoring is the impossibility to control the building structure condition in real time or close to the real time mode. It does not allow ascertaining the receiving of information on a critical condition of the structure in due time.

### BRIEF DESCRIPTION OF THE INVENTION

The objective of this invention is to ensure control over building structures in real time or close to the real time mode. Another objective is to provide a signalization for failure conditions of building structures (further called ‘FCBS’).

The technical outcome of the proposed method and building structure monitoring allows receiving information in real time or close to the real time mode required by the FCBS to check the mechanical load on the building structure's elements during the period of their exploitation. In particular, the technical result will be an automatic collection of information on the loads and determination of their correspondence to projected (i.e. pre-calculated during the design phase of the structure) loads both for compression and for stretching strain (or elastic strain, herein further also called ‘strain’) conditions upon request or in a pre-set time interval mode.

The above-mentioned technical result may be achieved with the inventive monitoring (control) method applied to a spatial building structure having a predetermined 3-dimensional (3D) scheme and predetermined elements, including construction elements and reinforcement (armature) cables and rods. The method comprises determining loads developed in the building structure's elements based on data measured for strain of the reinforcement elements and for compression of the construction elements, comparing the determined loads with threshold admissible strain and compression loads values pre-calculated during the design phase of the building structure and mapped to the scheme, and displaying the determined loads on a monitoring terminal (represented, for example, by a computer and a monitor or another information displaying device); wherein the measured data are generated in real time or in a predetermined time mode, and the measured data on the strain load are obtained by measuring deviations of electric or magnetic parameters at the rods or cables from pre-set threshold parameter values corresponding to the threshold admissible strain load, while the compression loads are determined by compression-measuring sensors (tension sensors) installed between the construction elements (such as concrete slabs, etc.).

The loads on the building structures elements may preferably be determined by a unit for control of the carrying capacity and spatial stability. This unit transmits (e.g. through a radio channel or wires) data on the measured load values to the monitoring terminal that automatically displays the values and shows the comparison of the values with the pre-calculated threshold admissible values mapped to the 3D scheme.

Data, allowing the determination of the load on the building structures, may be obtained from the autonomous electric or magnetic parameters sensors (e.g. see U.S. patent application Ser. No. 11/920,948 filed on 23 Nov. 2007 of the instant inventor, which Application is hereby incorporated by reference in its entirety), associated with operation of the reinforcement elements, or with operation of sensors, transmitting information on the loads to the monitoring terminal, automatically (in real time upon request from the monitoring terminal or within a pre-set time interval) determining and displaying the load values and results of their comparison with the pre-calculated threshold values and showing them at the 3D scheme of building structures.

The above-mentioned technical result is achieved in the inventive FCBS of a spatial business structure, comprising a control device for monitoring the building structure, which control device includes a monitoring terminal, allowing to process data on building structure elements and determine a failure condition of the building; a plurality of strain-measuring sensors of electric or magnetic parameters of the reinforcement elements that allows receiving data and determine the strain load of a certain reinforcement element of the building structure; a plurality of compression-measuring sensors installed between the construction elements of the building structure to obtain data on compression of the construction elements. This monitoring terminal also unit includes at least one data transmitting unit connected to the strain-measuring and compression-measuring sensors. The monitoring terminal includes additionally a receiver of the transmitted data.

### BRIEF DESCRIPTION OF DRAWINGS

FIG. 1 shows the building structure scheme displayed on the screen of the monitoring terminal, and a control device for monitoring the structure.

FIG. 2 shows a block-diagram of the building structure monitoring device.

FIG. 3 schematically shows a compression-measuring sensor.

Identical reference numerals in the drawings generally refer to the same elements in different figures. A first-time introduced numeral in the description is enclosed into parentheses.

### DETAIL DESCRIPTION OF PREFERRED EMBODIMENTS

While the invention may be susceptible to embodiment in different forms, there are shown in the drawings, and will be described in detail herein, specific exemplary embodiments of the present invention, with the understanding that the present disclosure is to be considered an exemplification of the principles of the invention, and is not intended to limit the invention to that as illustrated and described herein.

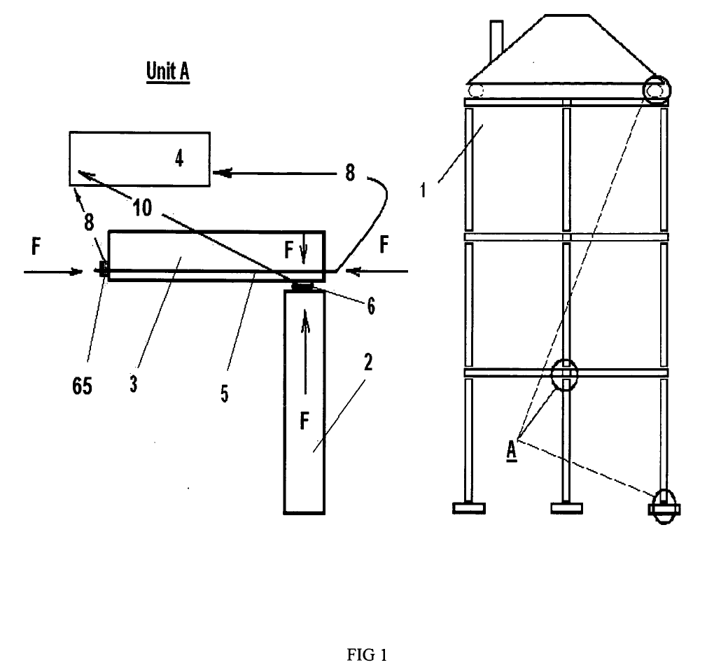

FIG. 1 illustrates the proposed method envisaging display of a building structure scheme (1), and, by the operator's choice, its separate unit A with resulting loads and their comparison with pre-calculated admissible threshold load values. The unit A exemplarily incorporates a pillar (2) and beam (3). The unit A is equipped with an autonomous device (4) controlling the carrying capacity and stability of the structure. The device 4 is connected to a reinforcement rod (5) of the beam 3, to a sensor (6) measuring compression (also known as tension-measured sensors) and to a sensor (65) so arranged that measuring strain (extension) of the rod 5.

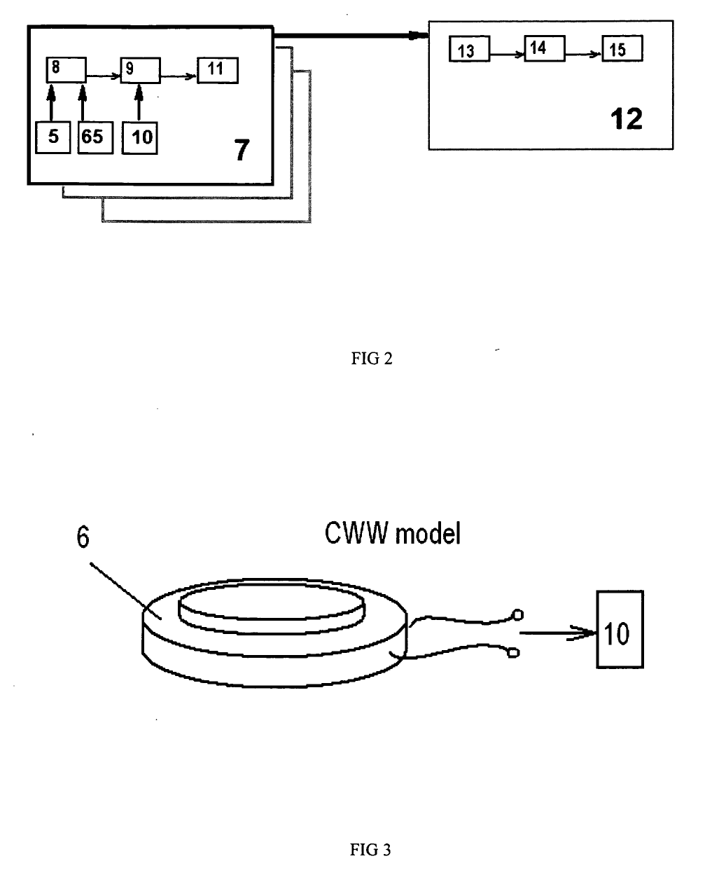

FIG. 2 presents a block-diagram of the device 4 incorporating a unit (7) (generally, the device 4 may include a plurality of such units 7) for control of the carrying capacity of the structure's elements. The unit 7 includes a block (8) for determination of electric or magnetic parameters at the reinforcement rod 5 (shown on FIG. 1) that correspond to the amount of strain of the rod. The block 8 may be represented, for example, by a voltmeter, or an Ohm-meter and a source of electric current (not shown). The unit 7 includes a comparator (9) having an input port (10) for connection to a compression-measuring sensor (6) (shown on FIGS. 1 and 3), wherein the comparator 9 is capable of comparing: —values of electric or magnetic parameters on the reinforcement rod 5 with a pre-set threshold value corresponding to a threshold mechanical strain (also known as a ‘strain-deforming condition’) of the reinforcement rod (see, for example, an inventor's certificate of the USSR No. 246901), and —values of voltage at the output of the compression-measuring sensor 6 with a pre-set threshold value corresponding to a threshold mechanical compression of the reinforcement element of the building structure. The unit 7 includes a data transmission block (11) transmitting data on results of the comparison.

The block 8 is capable of switching to various reinforcement rods or reinforcement cables to determine the electric or magnetic parameters at these rods or cables, which parameters are associated with the amount of strain experienced by the reinforcement elements. The comparator 9 is capable of switching the port 10 to several compression-measuring sensors 6.

The device 4 includes a monitoring terminal (12) comprising a data receiving unit (13) receiving data from the unit 7, a computer (14) processing the data, and a monitor (15) displaying the results of the processing.

FIG. 3 schematically shows the CWW model of the sensor 6 (or the sensor 65) made by Dacell Co. Ltd. (South Korea), designed for use in the construction industry, namely for control of loads. The following Table 1 lists its characteristics.

TABLE 1

| | |
|---|---|
| Nominal range (n.r.) | 50, 100, 200, 500 kG, 1, 2, 3, 5, 10, 20, 30, |
| | 50, 100, 150, 200 T |
| Nominal output signal (n.s.) | 1.5 mV ± 0.4% |

The monitoring terminal 12 may be installed in the building under control, near that building, or in a car.

The computer 14 has a database storing data on the building structure and the pre-calculated threshold values of the building structure elements (admissible loads) based both on calculation of the spatial carrying capacity of the structure and of the carrying capacity of predetermined assemblies and elements of the building structure.

Should the carrying capacity of some assemblies or elements be lost, the spatial stability of the structure may still retain the balance, but people may be injured, or engineering systems and equipment may be damaged. At the same time, the building structure may lose balance (stability) upon mechanical loads (in one assembly or element), which are much less then the threshold admissible values that may result in loss of the carrying capacity.

The comparator 9 may use the smaller of two threshold values, obtained for a certain element of the building structure, based on the calculation of the stability of the structure as a whole and on the calculation of the carrying capacity of this element.

The computer 14 may be loaded with predetermined software that allows to: —review (monitor) data received from the data receiver 13, (where they have arrived, for example, through the radio channel, from the unit 7, installed in the building) in real time or in a predetermined time interval mode; —automatically send signals, should the threshold mechanical tension (strain or compression) of a certain element be exceeded, in which this case the monitoring system can be classified as a FCBS system; —display on the monitor screen this certain element, the adjacent elements, and their location within the spatial building structure (FIG. 1); —provide recommendations on measures to prevent the collapse of the building structure.

In some embodiments, the monitoring system may contemplate the transmission of information to the monitoring terminal from several sensors, i.e. it may be assembled without the devices controlling the carrying capacity. In that case, sensors of electric or magnetic characteristics of the reinforcement include also a device measuring characteristics of electric current or magnetic field, current source and a device transferring data on electric or magnetic parameters of the reinforcement. The compression-measuring sensor includes also a voltmeter and a block, transmitting data on voltage, measured by the voltmeter. Therefore, the computer software may determine, in addition to the functions listed above, the correspondence of data, received from the sensors with threshold mechanical loads of certain elements of the building structures.

1-4. (canceled)

5. A method for monitoring a state of a building structure, including a plurality of construction elements, and a plurality of reinforcement elements, with corresponding pre-calculated admissible threshold stretching and compression loads, said method comprising the steps of:
determining actual stretching loads developed in said reinforcement elements based on data measured for stretching strain, and determining actual compression loads developed in said construction elements based on data measured for compression;
comparing said determined loads with said corresponding pre-calculated admissible threshold stretching and compression loads; and
displaying said determined loads and results of said comparing on a monitoring terminal; wherein
said measured data for stretching strain and compression are generated in real time or in a predetermined time mode, and said measured data on the stretching load are obtained by measuring deviations of electric or magnetic parameters at said reinforcement elements from pre-set stretching threshold parameters, and said measured data on the compression load are determined by compression-measuring sensors installed between said construction elements.

6. A system for determination of failure conditions of a building structure having a plurality of reinforcement elements with corresponding pre-calculated threshold stretching loads and having a plurality of construction elements with corresponding pre-calculated threshold compression loads, the system including a monitoring device for monitoring a state of the building structure, said monitoring device is capable of connecting to a plurality of means for measuring stretching loads developed in said reinforcement elements, and to a plurality of means for measuring compression loads developed between said construction elements; said monitoring device comprising:
a monitoring terminal associated with said plurality of means for measuring stretching and compression loads, said terminal is capable of processing data for stretching and compression loads in real time upon request or within a pre-set time interval, and said terminal is capable of displaying said data for stretching and compression loads.

7. The system according to claim 6, wherein said monitoring device further comprises:
a control unit for control of the carrying capacity and spatial stability of said structure, said control unit is associated with said terminal, said control unit including:
a stretching strain determination block for determination of electric or magnetic parameters of said reinforcement elements, wherein said parameters correspond to actual stretching loads measured by said corresponding means for measuring stretching loads;
a comparator associated with said strain determination block, said comparator is capable to generate stretching data obtained by measuring deviations of said parameters at the corresponding reinforcement elements from pre-set parameters corresponding to the stretching threshold loads, said comparator is capable of switchably connecting to said means for measuring compression loads, wherein compression data are obtained from said means for measuring compression loads, said comparator is capable of comparing said compression data with the corresponding pre-calculated threshold compression loads.

8. The device according to claim 7, wherein said control unit is associated with said terminal either through a wired or a wireless connection.
